(19) United States
(12) Patent Application Publication
(10) Pub. No.: US 2010/0315999 A1
(43) Pub. Date: Dec. 16, 2010

(54) USE OF BLOCK ACKNOWLEDGEMENT POLICY FOR WIRELESS NETWORKS

(75) Inventors: Naveen Kumar Kakani, Texas (US); Jakub Majkowski, Helsinki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/814,625

(22) Filed: Jun. 14, 2010

Related U.S. Application Data
(60) Provisional application No. 61/186,814, filed on Jun. 13, 2009.

(51) Int. Cl. H04W 40/00

(52) U.S. Cl. 370/328

(57) ABSTRACT

Various example embodiments are disclosed herein. According to an example embodiment, a technique may include receiving, via a wireless network, a frame indicating whether or not regular acknowledgements may be used (or alternatively indicating whether or not data frames with fragmented payloads may be used), in addition to block acknowledgements. In example embodiments, an Add Block Acknowledgement (ADDBA) response frame or a block Acknowledgement may be received indicating whether or not regular acknowledgements may be used to acknowledge receipt of data frames, or alternatively, indicating whether or not data frames with fragmented payloads may be transmitted.

### RELATED APPLICATION

The subject application claims priority benefit, under 35 U.S.C. 119(e), to U.S. Provisional Patent Application No. 61/186,814, filed Jun. 13, 2009.

### TECHNICAL FIELD

This description relates to wireless networks.

### BACKGROUND

Wireless devices may operate in a full-power state to transmit and receive data, and perform other activities. From time to time, wireless devices may switch to a low-power or sleep state. Battery power may be conserved by allowing a wireless device to spend less time transmitting, and spend more time in a low power or sleep state.

In addition, wireless devices may send an acknowledgement or ACK to indicate that a data frame (or other frame) was received. In some cases, a regular acknowledgement may be used to acknowledge receipt of a single data frame. In other cases, a block acknowledgement, which may be more efficient than a regular ACK, may be used to acknowledge receipt for a group or block of data frames.

### SUMMARY

According to an example embodiment, an apparatus may include a processor, the apparatus being configured to receive, via a wireless network, a frame indicating whether or not regular acknowledgements may be used, in addition to block acknowledgements.

According to an example embodiment, an apparatus may include a processor, the apparatus being configured to: transmit, via a wireless network, a frame indicating whether or not regular acknowledgements may be used, in addition to block acknowledgements.

According to an example embodiment, a method may include receiving, via a wireless network, a frame indicating whether or not regular acknowledgements may be used, in addition to block acknowledgements.

According to another example embodiment, an apparatus may include means for receiving, via a wireless network, a frame indicating whether or not regular acknowledgements may be used, in addition to block acknowledgements.

According to an example embodiment, a method may include transmitting, via a wireless network, a frame indicating whether or not regular acknowledgements may be used, in addition to block acknowledgements.

According to another example embodiment, an apparatus may include means for transmitting, via a wireless network, a frame indicating whether or not regular acknowledgements may be used, in addition to block acknowledgements.

According to another example embodiment, an apparatus may include a processor, the apparatus being configured to: transmit, via the wireless network, a request frame to request a use of block acknowledgements to acknowledge receipt of one or more data frames; and receive a response frame indicating that block acknowledgements may be used, and also indicating whether or not regular acknowledgements may be used.

According to another example embodiment, an apparatus may include a processor, the apparatus being configured to: transmit, via the wireless network, a request frame to request a use of block acknowledgements to acknowledge receipt of one or more data frames; and receive a response frame indicating that block acknowledgements may be used, and also indicating whether or not data frames with fragmented payloads may be transmitted.

According to an example embodiment, an apparatus may include a processor, the apparatus being configured to: receive, via the wireless network, a request frame to request a use of block acknowledgements to acknowledge receipt of one or more data frames; and transmit a response frame indicating that block acknowledgements may be used, and also indicating whether or not regular acknowledgements may be used.

According to an example embodiment, an apparatus may include a processor, the apparatus being configured to: receive, via the wireless network, a request frame to request a use of block acknowledgements to acknowledge receipt of one or more data frames; and transmit a response frame indicating that block acknowledgements may be used, and also indicating whether or not data frames having a fragmented payload may be transmitted.

An apparatus may include a processor, the apparatus being configured to: transmit, via a wireless network, one or more data frames; and receive a block acknowledgement that acknowledges receipt for one or more of the data frames, the block acknowledgement indicating whether or not regular acknowledgements may be used, in addition to the use of block acknowledgements, to acknowledge receipt of subsequent data frames.

According to another example embodiment, an apparatus may include a processor, the apparatus being configured to: receive, via a wireless network, one or more data frames; and transmit a block acknowledgement that acknowledges receipt for one or more of the data frames, the block acknowledgement indicating whether or not regular acknowledgements may be used, in addition to the use of block acknowledgements, to acknowledge receipt of subsequent data frames.

According to an example embodiment, a method may include transmitting a message indicating that individual data frames having a fragmented payload may not be transmitted.

According to another example embodiment, an apparatus may include a processor, the apparatus being configured to: transmit, via a wireless network, one or more data frames; and receive a block acknowledgement that acknowledges receipt for one or more of the data frames, the block acknowledgement indicating whether or not data frames with a fragmented payload may be transmitted.

According to another example embodiment, a method may include transmitting, via a wireless network, one or more data frames; and receiving a block acknowledgement that acknowledges receipt for one or more of the data frames, the block acknowledgement indicating whether or not data frames with a fragmented payload may be transmitted.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a diagram illustrating operation of transmitting and receiving wireless stations where ACKs and fragmented data frames may be used, in addition to block ACKs, according to an example embodiment.

FIG. 3 is a diagram illustrating operation of transmitting and receiving wireless stations where block ACKs may be used, and where regular ACKs and fragmented data frames may not be used according to an example embodiment.

FIG. 4 is a timing diagram according to an example embodiment.

FIG. 5 is a block diagram illustrating a format of Add block ACK (ADDBA) Request/Response messages according to an example embodiment.

FIG. 6 is a diagram illustrating a block acknowledgement according to an example embodiment.

FIG. 7 is a flow chart illustrating operation of a wireless node according to an example embodiment.

FIG. 8 is a flow chart illustrating operation of a wireless node according to an example embodiment.

FIG. 9 is a flow chart illustrating operation of a wireless node according to an example embodiment.

FIG. 10 is a flow chart illustrating operation of a wireless node according to an example embodiment.

FIG. 11 is a block diagram of a wireless node according to an example embodiment.

### DETAILED DESCRIPTION

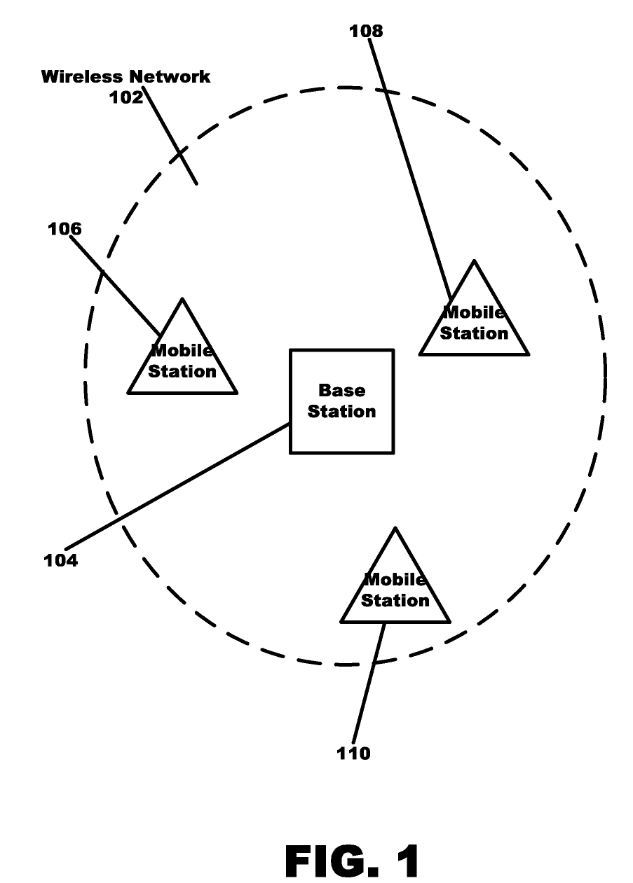

FIG. 1 is a block diagram of a wireless network 102 including a base station (BS) 104 and three (wireless) mobile stations (MSs) 106, 108, 110 according to an example embodiment. Although not shown, mobile stations 106, 108 and 110 may be coupled to base station 104 via relay stations or relay nodes, for example. The wireless network 102 may include, for example, an IEEE 802.16 Wireless Metropolitan Area Network (WiMAX), an IEEE 802.11 Wireless Local Area Network (WLAN), or a cellular telephone network, according to example embodiments, or any other wireless network. The base station (BS) 104 may include a cellular or WiMAX base station (BS), a node B, an 802.11 WLAN access point (AP), or other infrastructure node, according to various example embodiments. The term “base station” (BS) may be used herein and may include any type of infrastructure node. The mobile (or wireless) stations 106, 108, 110 may include IEEE 802.11 WLAN devices, laptop or notebook computers, smartphones, personal digital assistants (PDAs), cellular telephones, WiMAX devices, wireless subscriber stations, or any other wireless device or wireless station, according to example embodiments. The term “wireless node” may include any type of wireless node, such as base stations, mobile stations, etc. While the present disclosure may use some of the terminology of IEEE 802.11 WLAN networks or other wireless standards, aspects of the present disclosure may be applicable to any networking or wireless technologies. One or more of the example embodiments may be applied to IEEE 802.11 and/or Wireless Gigabit Alliance (WGA) standards, including any wireless devices that may be compliant with these standards.

Although not shown in FIG. 1, two (or more) wireless (or mobile) stations may alternatively communicate directly with each other, without requiring an infrastructure node (e.g., AP, BS) therebetween. This direct communication between mobile stations may sometimes be referred to as a peer-to-peer communication, or an ad-hoc wireless network, for example. Therefore, the various embodiments and techniques described herein may be applied to mobile stations that communicate with an infrastructure node (e.g., in an infrastructure mode or the like), or directly with another mobile station (e.g., in ad-hoc mode or the like).

Data frames may be transmitted, and in some cases, an acknowledgement may be sent by the receiving station to the transmitting station to acknowledge receipt of the data frame(s). An example of a data frame may be a MAC (Media Access Control) Protocol Data Unit or MPDU, although this is merely an example and other types of data frames/packets may be used. An aggregate or group of data frames may be transmitted together, such as, for example, as an Aggregate MPDU, which may include a plurality or multiple MPDUs. Received data frames may be acknowledged by using a regular (or single frame) acknowledgement (regular ACK). Or, a block acknowledgement (or block ACK) may be used to acknowledge receipt of a group or block of or multiple data frames. Block ACKs may be considered to be a more efficient acknowledgement technique (as compared to a regular ACK or single ACK), since with a block ACK more frames may be acknowledged using fewer frames and fewer resources, for example.

According to an example embodiment, several different data transmission and acknowledgement mechanisms or modes may be used by wireless stations to transmit data frames and acknowledge their receipt. According to an example embodiment, some stations may support (or prefer to use) only some but not (necessarily) all of these transmission/acknowledgement mechanisms or modes.

For example, a single (or individual) data frame may be transmitted from a transmitting wireless station to a receiving wireless station, where the payload may be fragmented. In this mode, the fragmented data frames may be acknowledged using only regular ACKs, for example. In another mode, an individual data frame may be transmitted with an unfragmented (or complete) payload, and such data frame may be acknowledged using either a regular ACK or via a block ACK, for example. In another example data transmission/ACK mode, data frames may be transmitted via one or more aggregate data frames, and receipt of these data frames may be acknowledged via a block ACK (e.g., using only block ACKs), for example. These are some example transmission/ACK modes or mechanisms, and others may be used.

For example, a MAC Protocol Data Unit, or MPDU, may receive a MSDU or MAC Service Data Unit to be transmitted as a MPDU payload. For example, if there are insufficient resources remaining (or available to the transmitting station), a station may fragment a MSDU and send the MDPU with the fragmented payload (fragment of the MSDU). Alternatively, the complete MSDU may be transmitted as a payload of the MPDU. Alternatively, an aggregate data frame (e.g., aggregate MPDU) may be used to send an aggregate or group of MPDUs together, which may be more efficient since some overhead may be saved by transmitting an aggregate data frame (or aggregate MPDU).

In some cases, stations may allow both regular ACKs and block ACKs to be used to acknowledge receipt of data frames, e.g., with regular ACKs used for individual data frames (with either fragmented or complete payloads), and block ACKs used for aggregate data frames or individual data frames having complete payloads

From a perspective of a transmitting station, it may be advantageous or efficient to allow the transmitting station to use regular ACKs (including to acknowledge fragmented or unfragmented data frames) and block ACKs (to acknowledge aggregate data frames or unfragmented data frames).

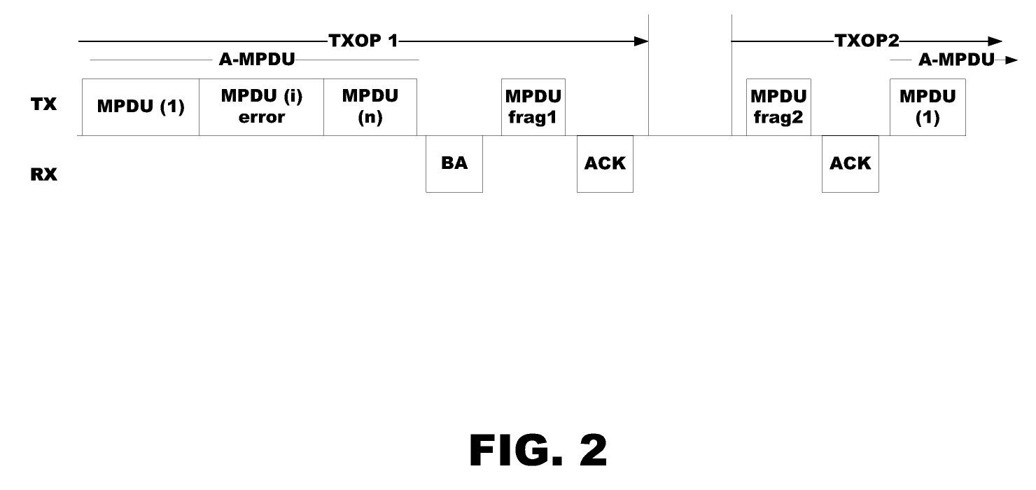

FIG. 2 is a diagram illustrating operation of transmitting and receiving wireless stations where ACKs and fragmented data frames may be used, in addition to block ACKs, according to an example embodiment. A transmitting station (TX) transmits data frames during two transmit opportunities: TXOP1, and TXOP2, where the wireless media is available to the transmitting station (TX) for transmission during such TXOPs. The receiving station (RX) may acknowledge receipt of the data frames during TXOP1 and TXOP2. The transmitting station (TX) may transmit an aggregate data frame (A-MPDU) that includes an aggregate of data frames MPDU(1), MPDU(i), . . . MPDU(n). Although, in this example, there was an error with transmission of MPDU(i) and thus, MPDU(i) was not received by the receiving station (RX). After receiving the aggregate data frame (A-MPDU) in TXOP1, the receiving station (RX) may send a block acknowledgement (BA) to the transmitting station to indicate or acknowledge which data frames were received, e.g., the BA may include a bit map that indicates which data frames were received, and which data frames have not been received. In this example, the BA may indicate that MPDU(i) was not received, or received with errors, e.g., no ACK for MPDU(n) in BA, or may bit map in BA may provide a NAK or negative acknowledgement, depending on how the bit map of the BA is interpreted.

Therefore, the transmitting station (TX) would like to retransmit the MPDU(i) that was not received. However, in this example, insufficient time is remaining in the TXOP1 to transmit a MPDU or data frame with a complete payload (or unfragmented MSDU, for example). Therefore, to allow greater usage of the remaining time/resources in the TXOP1, the transmitting station (TX) may fragment the MSDU or payload for the MPDU(i) into two fragments. (or may fragment a payload for a next data frame, in the event no data frame is being retransmitted). The transmitting station (TX) then retransmits the data frame with the fragmented payload with the first fragment (MPDU frag1), which is acknowledged by the receiving station using a regular (or single) ACK. During a subsequent TXOP, shown as TXOP2, the transmitting station (TX) may then transmit a data frame that includes the second fragment (MPDU frag2), which is acknowledged by receiving station using a regular ACK. The transmitting station may then transmit a next aggregate data frame (A-MPDU) during TXOP2.

While this arrangement (e.g., allowing both ACKs for fragments and blocks ACKs to be used) shown in FIG. 2 may be efficient from the perspective of the transmitting station (TX), since it allows greater usage of the available TXOP resources (e.g., last portion of TXOP1 is used via transmission of fragment since there was not sufficient time in TXOP1 to transmit a data frame with complete payload), this approach may be relatively power-inefficient for the receiving station (RX). In this example, the receiving station is required to stay in full power mode after receiving the BA in TXOP1, so the receiving station may receive the MPDU frag1 and transmit the ACK for the frag1. The remaining fragment (frag2) of this data frame is not received until TXOP2, and therefore, the data frame cannot be passed up to higher layer applications for processing until both fragments (frag1, frag2) have been received. Thus, this technique may be considered inefficient from the perspective of the receiving station, as it consumes significant power to receive the fragments at the end of the TXOP1, without providing an advantage to the receiving station. Also, a head of line (HOL) problem may arise because, according to an example embodiment, an aggregate data frame (A-MPDU) may not be transmitted in TXOP2 until the remaining fragment (frag2) has first been transmitted and ACKed, for example.

Therefore, according to an example embodiment, a receiving station may identify or specify at least one data transmission/acknowledgement mode that may be used (this may also indicate one or more ACK/transmission modes that should not be used). For example, the receiving station may send a message or frame to the transmitting station that indicates that block ACKs are supported (or may be used), but regular ACKs (or regular ACKs to ACK data frames with fragmented payloads) are not supported/may not be used. Thus, according to an example embodiment, in the case where both transmitting and receiving stations have agreed to use block ACKs, the receiving station may send a frame to the transmitting station indicating whether or not regular ACKS and/or transmission of data frames with fragmented payloads are not supported/should not be used. This may be useful where the receiving wireless station relies on battery power, and conserving battery power is important, e.g., for a mobile station, although this technique may be used for all wireless stations. For example, the receiving wireless station (receiving data frames) may send a frame to the transmitting station, e.g., during a block ACK agreement negotiation phase or as part of a block ACK exchange, to indicate that regular ACKs (or regular ACKs to ACK data frames with fragmented payloads) should not be used for one or more traffic streams or to prohibit or deny the use of these modes or mechanisms for such traffic stream(s) or flow(s). In one example embodiment, the receiving station may send a frame that indicates that data frames with fragmented payloads may not be used (e.g., for a specific traffic stream or TID).

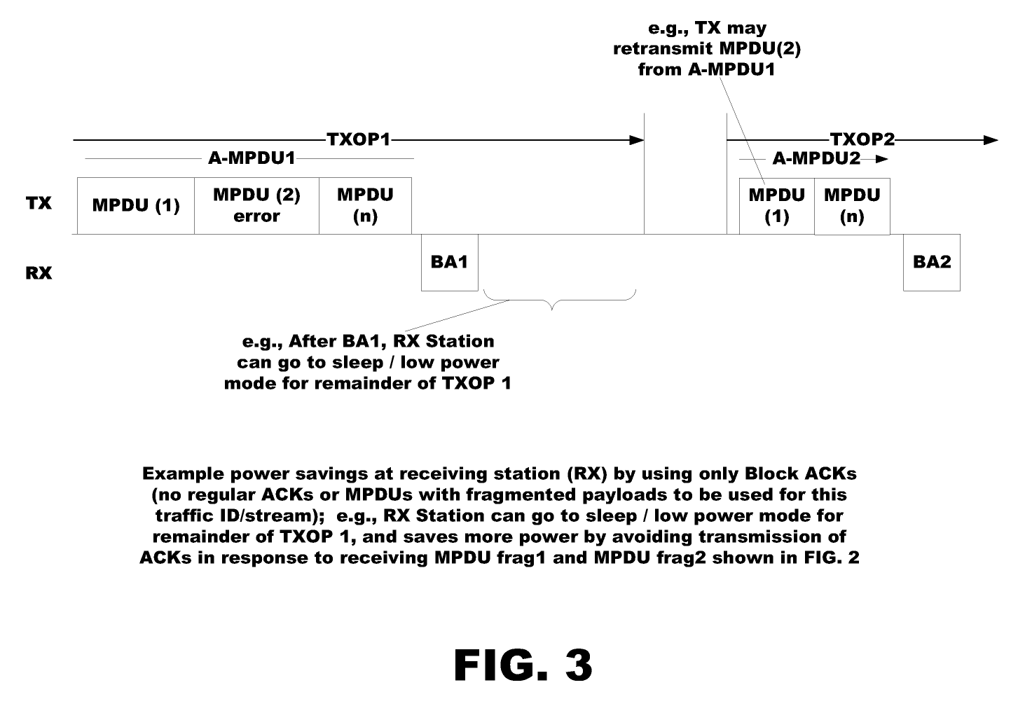

FIG. 3 is a diagram illustrating operation of transmitting and receiving wireless stations where block ACKs may be used, and where regular ACKs and fragmented data frames may not be used according to an example embodiment. In this example, the receiving station (RX) has sent a frame (not shown) to the transmitting station (TX), for example, that indicates that block ACKs may be used, but that regular ACKs may not be used (or alternatively that regular ACKs may not be used to acknowledge data frames with fragmented payloads). Or alternatively, e.g., after establishing (or as part of establishing) the use of block ACKs between a transmitting station and receiving station, the receiving station may send a message to the transmitting station indicating that data frames with fragmented payloads may not be transmitted.

Power savings may result for the receiving station (RX) in this example embodiment shown in FIG. 3, as compared to the embodiment illustrated in FIG. 2. For example, the transmitting station (TX) is unable to transmit more data after receiving the block ACK (BA1) in TXOP1, since (for example) there is only time to transmit a data frame with fragmented payload, but fragmented payloads are not permitted, as specified by the receiving station. Thus, the transmitting station does not indicate “more data” in the header of the last MPDU (MPDU(n)) of the A-MPDU1. Therefore, for example, the receiving station (RX) may go to sleep or enter low power mode or state for the remainder of TXOP1 (after BA1), as no further data is expected from transmitting station (TX) during TXOP1. Further power savings are also achieved at the receiving station since the receiving station does not need to send two regular ACKs in response to the receipt of two fragments (MPDU frag1, MPDU frag2).

According to an example embodiment, as noted above, the receiving station (RX) may send a message to the transmitting station (TX), e.g., during a block ACK agreement negotiation phase or as part of a block ACK exchange, to indicate whether or not regular acknowledgements (or regular ACKs) may be used, in addition to block acknowledgements. Thus, block ACKs may be permitted or supported for a data transmission between two stations or for a traffic stream, and a field (such as a Block ACK Only field) in the message (sent by receiving station to transmitting station) may indicate whether or not regular ACKs may be used (in addition to the block ACKs).

In one example embodiment, data frames having fragmented payloads may be acknowledged only with regular ACKs, and block ACKs may be used to acknowledge both individual data frames (e.g., MPDUs) and aggregate data frames (e.g., A-MPDUs). Thus, in this example, a message from the receiving station that indicates that regular ACKs may not be used for a particular traffic stream, this message, in effect also indicates that individual data frames with a fragmented payload may not be used (because regular ACKs are prohibited by the message, and regular ACKs are the only ACK mechanism for fragments, in this example).

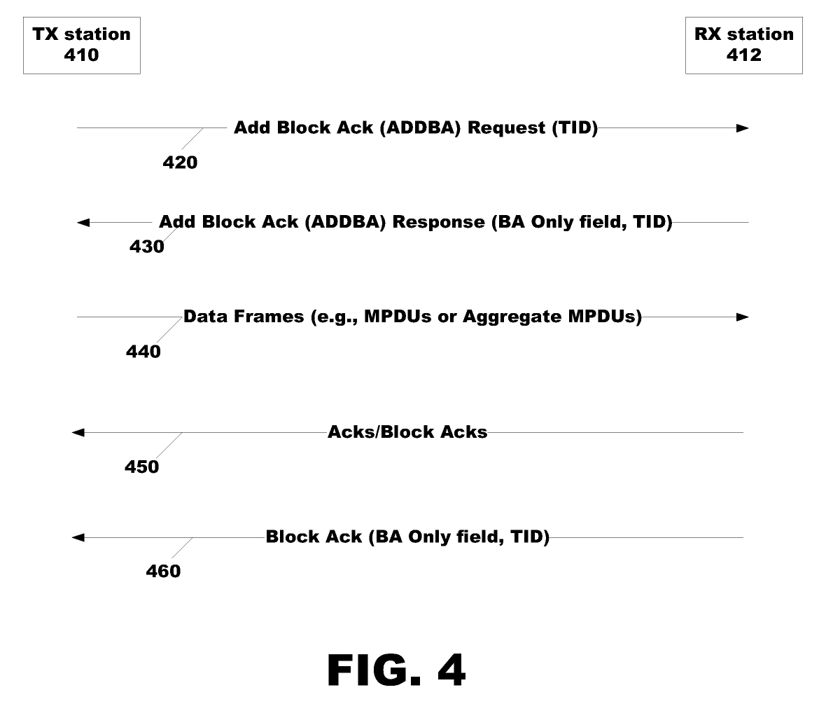

FIG. 4 is a timing diagram according to an example embodiment. A transmitting station 410 may transmit data to a receiving station 412. A block ACK agreement negotiation phase may include a request message 420 and a response message 422. For example, transmitting station may transmit an Add Block Ack (ADDBA) request to the receiving station 412, indicating (or requesting) that block acknowledgements should be used for a traffic stream. ADDBA message 420 may include a traffic ID (TID), traffic stream ID, flow ID, or other identifier (such as receiving station or transmitting station addresses) that may identify a stream or flow, for example. The receiving station 412 may then send an Add Block Ack (ADDBA) response message 430 that may include a field (such as a block ACK only field), that indicates (in addition to the use of block ACKs which is supported) whether or not regular ACKs may be used to acknowledge receipt of data frames for a specified TID/traffic stream. For example, a receiving station may, at least in some cases, achieve power savings by prohibiting or not allowing, use of regular ACKs/data frames with fragmented payloads, as described above with reference to the examples shown in FIGS. 2 and 3. For example, the ADDBA request 420 may request use of block ACKs, while the ADDBA response 430 may confirm that block ACKs may be used (are supported by RX station 412), and may indicate whether or not regular ACKs (and/or data frames with fragmented payloads) are supported or allowed by the receiving station 412.

At 440, one or more data frames may be transmitted by the transmitting station 410 to the receiving station 412. The data frames may be individual data frames or MPDUs (for example), or aggregate data frames or aggregate MPDUs (or A-MPDUs).

At 450, in response to receiving data frames, the receiving station 412 may transmit ACKs and/or block ACKs to the transmitting station. In an example embodiment, block ACKs may be used, for example, to acknowledge data frames sent as individual data frames (MPDUs) and/or to acknowledge data frames sent as an aggregate data frame (e.g., A-MPDU). Also, according to an example embodiment, regular ACKs will/may be used by receiving station 412 to acknowledge receipt of data frames (and data frames with fragmented payloads will be transmitted by TX station 410) only if the BA only field in the ADDBA response message 430 indicates that regular ACKs may be used.

At 460, a block ACK is transmitted from the receiving station 412 to the transmitting station 410 to acknowledge receipt of one or more data frames (received either as individual MPDUS or received in an aggregate data frame or A-MPDU). The block ACKs may allow a receiving station another opportunity to indicate or specify to the transmitting station whether or not regular ACKs (in addition to block ACKs) are supported or not (and/or whether or not data frames with fragmented payloads may be used). Therefore, like the ADDBA response message 430, the block ACK at 460 may include a field, such as a block ACK only (or BA Only) field, that indicates whether or not regular ACKs (and/or data frames with fragmented payloads) may be used for a specific traffic flow. The block ACK may also include other fields, such as a TID (traffic ID) (or other identifier) that may identify the traffic flow, stream, etc., for which the BA only field applies, for example. By providing a BA Only field in the Block acknowledgement (or block ACK) 460, this may allow the receiving station to dynamically turn on and off support for regular ACKs, for example, after the block ACK mechanism or mode has been activated or enabled between two stations.

In an alternative embodiment, the transmitting station 410 and receiving station 412 may establish the use of block ACKs (e.g., for a TID or traffic stream). This may be accomplished via the ADDBA request request and ADDBA response, for example. As part of the block ACK negotiation (ADDBA request/response exchange) or as part of the block ACK exchange, the receiving station 412 may send a message to the transmitting station 410 indicating that data frames with fragmented payloads may not be transmitted to the receiving station. Thus, a field may be provided in the ADDBA response or the Block ACK indicating that data frames with fragmented payloads may not be transmitted. This field may be called a “Block ACK Only” or may be referred to as a “No Fragments” field, as examples. In such case, upon receipt of such message, the transmitting station 410 may be prohibited or precluded from transmitting data frames or individual MPDUs having a fragmented payload to the receiving station (e.g., for all traffic or for a specified TID or traffic stream). However, the transmitting station, in such example, may still be able to transmit individual data frames/MPDUs with complete (or unfragmented) payloads, and the receiving station may Acknowledge receipt of such data frames with complete payloads using either regular ACKs or block ACKs. Of course, aggregated data frames or A-MPDUs may be transmitted and block ACKs may also be used to acknowledge data frames received via individual or aggregate data frames.

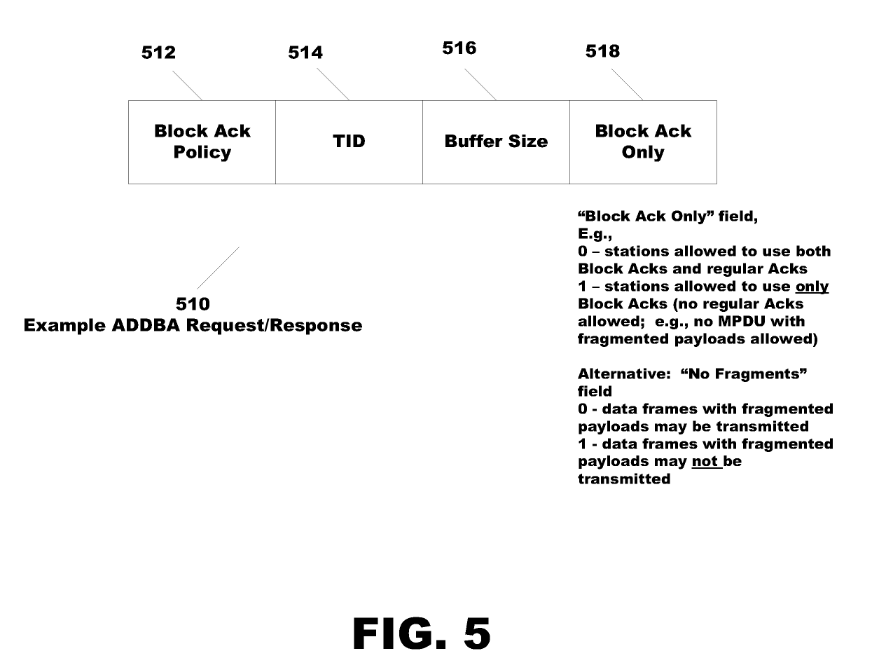

FIG. 5 is a block diagram illustrating a format of Add block ACK (ADDBA) Request/Response messages according to an example embodiment. An ADDBA message 510 may be used as an ADDBA request message and/or ADDBA response message. A block ACK policy field 512 may identify a block acknowledgement policy or a type of block acknowledgement that is requested or should be used to provide block ACKs for this traffic ID. Example block ACK policies may include an immediate block ACK, and a policy where delayed block ACK is permitted. A TID (or traffic identifier) 514 may identify a traffic stream or flow for which the ADDBA request/response applies is provided. The TID may also be referred to as a TSID (traffic stream identifier) or other identifier. A buffer size field 516 may identify a size or number of buffers to be allocated (ADD BA response), or requested to be allocated (ADDBA request) for the block ACKs.

A block ACK Only field 518 may indicate whether or not, in addition to block ACKs, regular ACKs are supported, or may be used, for the specified TID. For example, a 0 for the BA only field 518 may indicate that stations may use both block ACKs and regular ACKs, and a 1 for the BA only field may indicate that only block ACKs may be used for this TID (e.g., no regular ACKs should be used, and/or MPDUs with fragmented payloads should not be transmitted).

Alternatively, field 518 may be a “No Fragments” field that indicates that the transmitting station may not transmit data frames having a fragmented payload. This message or instruction may be sent, e.g., in a case where block ACKs are used, to improve power savings at the receiving station, as noted above with respect to FIG. 3. In an example embodiment, in this situation, the transmitting station may still transmit individual data frames or MPDUs having a complete or unfragmented payload (e.g., which may be ACKed via regular ACK or block ACK), and aggregate data frames (e.g., which may be ACKed via block ACK).

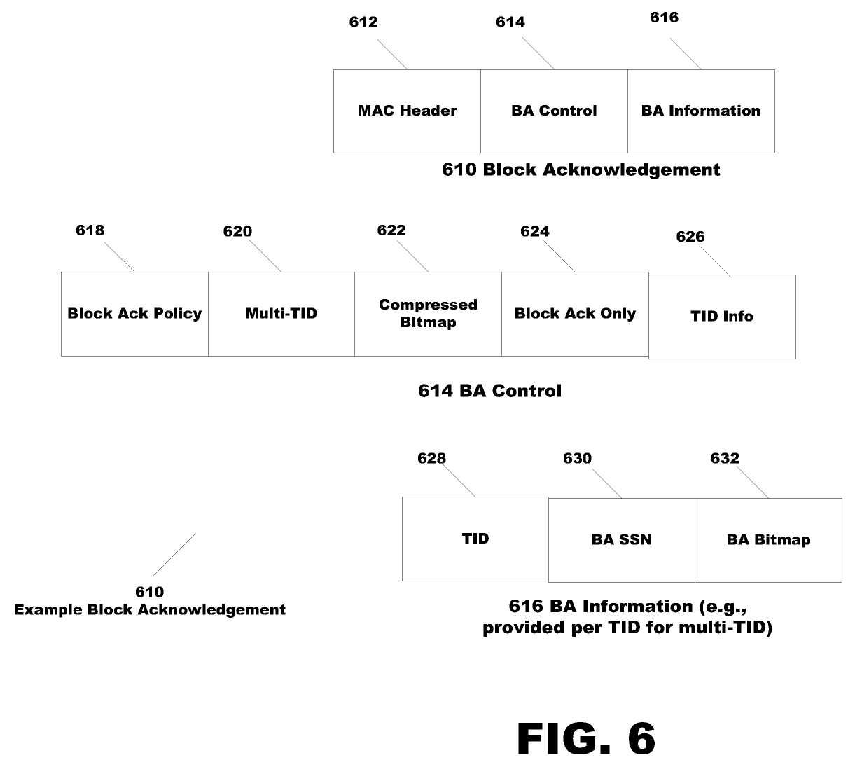

FIG. 6 is a diagram illustrating a block acknowledgement according to an example embodiment. As noted above, the block ACK 610 may provide a technique to allow the receiving station to dynamically turn on or off the regular ACK/fragmented payload support, for example.

Block ACK 610 may include a MAC header 612, which may include an address of the transmitting station, an address of the receiving station; a block ACK control (or BA control) field 614; and a block ACK (or BA) information 616.

BA control field 614 may include a block ACK policy field 618 (e.g., specifying immediate policy, or delayed block ACKs allowed), a multi-TID that indicates whether or not the BA control 614 (at least the BA only 624) and/or the BA information 616 is provided for each of a plurality of TIDs.

A compressed bitmap 622 may be provided to acknowledge a group of data frames. In an example embodiment, a block ACK only field 624 may indicate whether or not a regular ACK (in addition to a block ACK) (and/or data frame with fragmented payload) may be used for a specified TID. TID info 626 identifies the traffic ID<traffic stream, flow, or other identifier.

BA control information 614 may be provided for each TID, in the case of multiple TIDs. For each TID, the BA control information 614 may include a TID 628, which identifies the traffic ID or traffic stream, a block ACK bitmap 632 that may include a bit to acknowledge received or not each of a plurality of data frames, and a block ACK starting sequence number (BA SSN) 630 that identifies the first data frame for which the block ACK bitmap acknowledges receipt.

According to an example embodiment, an apparatus may include a processor, the apparatus being configured to: receive (e.g., by processor 1104 and/or transceiver 1102), via a wireless network, a frame indicating whether or not regular acknowledgements may be used, in addition to block acknowledgements.

In an example embodiment, the apparatus may be further configured to receive (e.g., by processor 1104 and/or transceiver 1102) the frame indicating whether or not a data frame with a fragmented payload may be transmitted.

In an example embodiment, the apparatus being configured to receive (e.g., by processor 1104 and/or transceiver 1102) may include the apparatus being configured to receive the frame indicating whether or not transmission of data frames with a fragmented payload and regular acknowledgements may be used.

In an example embodiment, the apparatus may be further configured to transmit (e.g., by processor 1104 and/or transceiver 1102), via the wireless network, a request frame to request a use of block acknowledgements to acknowledge receipt of one or more data frames; and receive (e.g., by processor 1104 and/or transceiver 1102) a response frame indicating that block acknowledgements may be used, and also indicating whether or not regular acknowledgements may be used.

In an example embodiment, the apparatus may be further configured to: transmit (e.g., by processor 1104 and/or transceiver 1102), via the wireless network, an Add Block Acknowledgement (ADDBA) request frame to request a use of block acknowledgements to acknowledge receipt of one or more data frames associated with a traffic identifier; and wherein the apparatus being configured to receive comprises the apparatus being configured to receive an Add Block Acknowledgement (ADDBA) response frame indicating that block acknowledgements may be used, and also indicating whether or not regular acknowledgements may be used to acknowledge receipt of one or more data frames associated with a traffic identifier.

In an example embodiment, the apparatus may be further configured to receive a block acknowledgement that acknowledges receipt for one or more data frames, the block acknowledgement indicating whether or not regular acknowledgements may be used, in addition to the use of block acknowledgements, to acknowledge receipt of subsequent data frames.

In an example embodiment, the apparatus may be further configured to: transmit one or more data frames, either as individual MAC Protocol Data Units (MPDUs) or as part of a Aggregate MPDU.

In an example embodiment, the apparatus being configured to receive may include the apparatus being configured to receive a block acknowledgement that acknowledges receipt for one or more data frames, the block acknowledgement including, for each of a plurality of traffic identifiers, a field indicating whether or not regular acknowledgements may be used, in addition to the use of block acknowledgements, to acknowledge receipt of subsequent data frames associated with the traffic identifier.

According to another example embodiment, an apparatus may include a processor, the apparatus being configured to: transmit (e.g., by processor 1104 and/or transceiver 1102), via a wireless network, a frame indicating whether or not regular acknowledgements may be used, in addition to block acknowledgements.

In an example embodiment, the apparatus being configured to transmit may include the apparatus being configured to transmit the frame indicating whether or not transmission of data frames with a fragmented payload.

In an example embodiment, the apparatus may be further configured to: receive (e.g., by processor 1104 and/or transceiver 1102), via the wireless network, a request frame to request a use of block acknowledgements to acknowledge receipt of one or more data frames; and transmit (e.g., by processor 1104 and/or transceiver 1102) a response frame indicating that block acknowledgements may be used, and also indicating whether or not regular acknowledgements may be used.

In an example embodiment, the apparatus may be further configured to: receive (e.g., by processor 1104 and/or transceiver 1102), via the wireless network, an Add Block Acknowledgement (ADDBA) request frame to request a use of block acknowledgements to acknowledge receipt of one or more data frames associated with a traffic identifier; and wherein the apparatus being configured to transmit comprises the apparatus being configured to transmit an Add Block Acknowledgement (ADDBA) response frame indicating that block acknowledgements may be used, and also indicating whether or not regular acknowledgements may be used to acknowledge receipt of one or more data frames associated with a traffic identifier.

In an example embodiment, the apparatus may be further configured to transmit (e.g., by processor 1104 and/or transceiver 1102) a block acknowledgement that acknowledges receipt for one or more data frames, the block acknowledgement indicating whether or not regular acknowledgements may be used, in addition to the use of block acknowledgements, to acknowledge receipt of subsequent data frames.

In an example embodiment, the apparatus may be further configured to: receive (e.g., by processor 1104 and/or transceiver 1102) one or more data frames, either as individual MAC Protocol Data Units (MPDUs) or as part of a Aggregate MPDU.

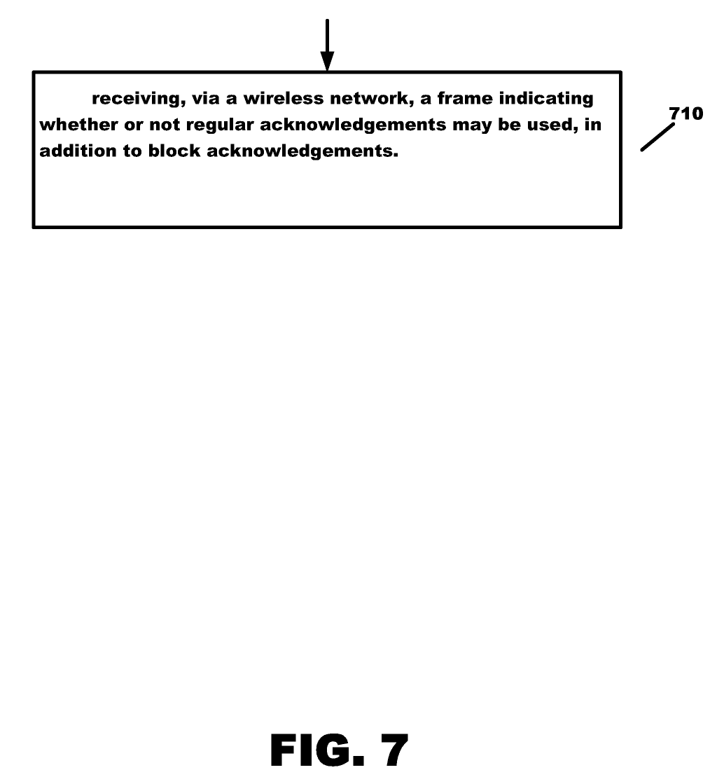

FIG. 7 is a flow chart illustrating operation of a wireless node according to an example embodiment. Operation 710 may include receiving (e.g., by processor 1104 and/or transceiver 1102), via a wireless network, a frame indicating whether or not regular acknowledgements may be used, in addition to block acknowledgements.

In an example embodiment, the receiving may include receiving the frame indicating whether or not a data frame with a fragmented payload may be transmitted.

In an example embodiment, the receiving may include receiving the frame indicating whether or not transmission of data frames with a fragmented payload and regular acknowledgements may be used.

The method may further include transmitting (e.g., by processor 1104 and/or transceiver 1102), via the wireless network, a request frame to request a use of block acknowledgements to acknowledge receipt of one or more data frames; and

The receiving may include receiving a response frame indicating that block acknowledgements may be used, and also indicating whether or not regular acknowledgements may be used.

The method may further include transmitting, via the wireless network, an Add Block Acknowledgement (ADDBA) request frame to request a use of block acknowledgements to acknowledge receipt of one or more data frames associated with a traffic identifier; and wherein the receiving may include receiving an Add Block Acknowledgement (ADDBA) response frame indicating that block acknowledgements may be used, and also indicating whether or not regular acknowledgements may be used to acknowledge receipt of one or more data frames associated with a traffic identifier.

The method may further include receiving (e.g., by processor 1104 and/or transceiver 1102) a block acknowledgement that acknowledges receipt for one or more data frames, the block acknowledgement indicating whether or not regular acknowledgements may be used, in addition to the use of block acknowledgements, to acknowledge receipt of subsequent data frames.

The method may further include transmitting (e.g., by processor 1104 and/or transceiver 1102) one or more data frames, either as individual MAC Protocol Data Units (MPDUs) or as part of a Aggregate MPDU.

In an example embodiment, the receiving may include receiving a block acknowledgement that acknowledges receipt for one or more data frames, the block acknowledgement including, for each of a plurality of traffic identifiers, a field indicating whether or not regular acknowledgements may be used, in addition to the use of block acknowledgements, to acknowledge receipt of subsequent data frames associated with the traffic identifier.

In another example embodiment, an apparatus may include:

means (e.g., by processor 1104 and/or transceiver 1102) for receiving, via a wireless network, a frame indicating whether or not regular acknowledgements may be used, in addition to block acknowledgements.

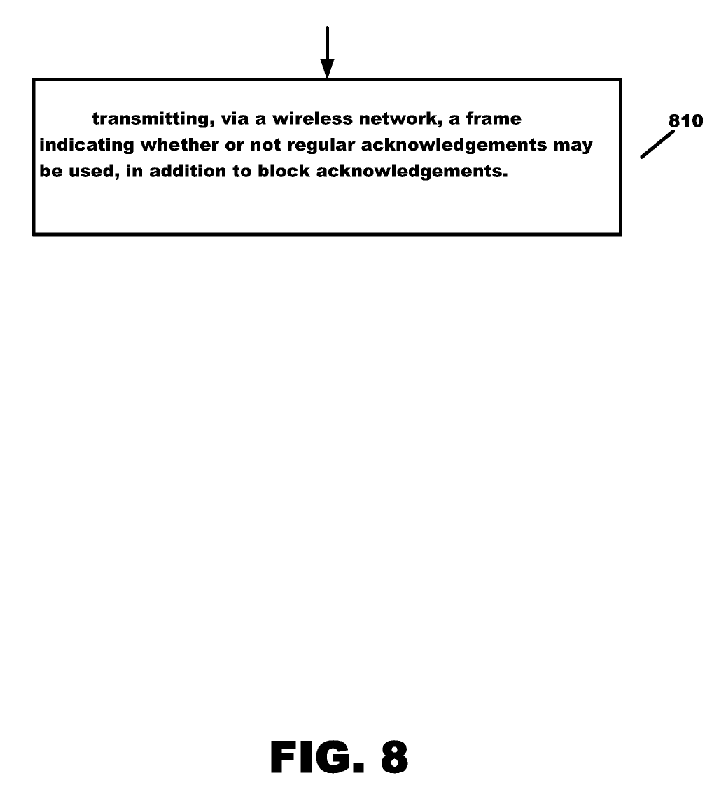

FIG. 8 is a flow chart illustration operation of a wireless node according to an example embodiment. Operation 810 may include transmitting (e.g., by processor 1104 and/or transceiver 1102), via a wireless network, a frame indicating whether or not regular acknowledgements may be used, in addition to block acknowledgements.

In an example embodiment, the transmitting may include transmitting the frame indicating whether or not transmission of data frames with a fragmented payload.

The method in FIG. 8 may further include receiving (e.g., by processor 1104 and/or transceiver 1102), via the wireless network, a request frame to request a use of block acknowledgements to acknowledge receipt of one or more data frames; and transmitting (e.g., by processor 1104 and/or transceiver 1102) a response frame indicating that block acknowledgements may be used, and also indicating whether or not regular acknowledgements may be used.

The method of FIG. 8 may further include receiving (e.g., by processor 1104 and/or transceiver 1102), via the wireless network, an Add Block Acknowledgement (ADDBA) request frame to request a use of block acknowledgements to acknowledge receipt of one or more data frames associated with a traffic identifier; and wherein the transmitting may include transmitting an Add Block Acknowledgement (ADDBA) response frame indicating that block acknowledgements may be used, and also indicating whether or not regular acknowledgements may be used to acknowledge receipt of one or more data frames associated with a traffic identifier.

According to another example embodiment, an apparatus may include: means (e.g., by processor 1104 and/or transceiver 1102) for transmitting, via a wireless network, a frame indicating whether or not regular acknowledgements may be used, in addition to block acknowledgements.

According to another example embodiment, an apparatus may include a processor, the apparatus being configured to: transmit (e.g., by processor 1104 and/or transceiver 1102), via the wireless network, a request frame to request a use of block acknowledgements to acknowledge receipt of one or more data frames; and receive (e.g., by processor 1104 and/or transceiver 1102) a response frame indicating that block acknowledgements may be used, and also indicating whether or not regular acknowledgements may be used. In an example embodiment, the apparatus being configured to transmit may include the apparatus being configured to transmit, via the wireless network, an Add Block Acknowledgement (ADDBA) request frame to request a use of block acknowledgements to acknowledge receipt of one or more data frames associated with a traffic identifier; and the apparatus being configured to receive may include the apparatus being configured to receive an Add Block Acknowledgement (ADDBA) response frame indicating that block acknowledgements may be used, and also indicating whether or not regular acknowledgements may also be used to acknowledge receipt of one or more data frames associated with a traffic identifier (or indicating whether or not data frames with fragmented payloads may be transmitted).

The response frame may include a Block Ack Only field indicating whether or not regular acknowledgements may be used.

The apparatus may be further configured to: transmit one or more data frames, either as individual MAC Protocol Data Units (MPDUs) or as part of a Aggregate MPDU; and receive a block acknowledgement that acknowledges receipt of one or more of the transmitted data frames, the block acknowledgement also including, for one or more traffic identifiers, a field indicating whether or not regular acknowledgements, in addition to block acknowledgements, may be used to acknowledge receipt of one or more subsequent data frames associated with the traffic identifier.

According to another example embodiment, an apparatus may include a processor, the apparatus being configured to: transmit (e.g., by processor 1104 and/or transceiver 1102), via the wireless network, a request frame to request a use of block acknowledgements to acknowledge receipt of one or more data frames; and receive (e.g., by processor 1104 and/or transceiver 1102) a response frame indicating that block acknowledgements may be used, and also indicating whether or not data frames with fragmented payloads may be transmitted.

An apparatus may include a processor, the apparatus being configured to: receive (e.g., by processor 1104 and/or transceiver 1102), via the wireless network, a request frame to request a use of block acknowledgements to acknowledge receipt of one or more data frames; and transmit (e.g., by processor 1104 and/or transceiver 1102) a response frame indicating that block acknowledgements may be used, and also indicating whether or not regular acknowledgements may be used (or indicating whether or not data frames having a fragmented payload may be transmitted).

An apparatus may include a processor, the apparatus being configured to: transmit (e.g., by processor 1104 and/or transceiver 1102), via a wireless network, one or more data frames; and receive (e.g., by processor 1104 and/or transceiver 1102) a block acknowledgement that acknowledges receipt for one or more of the data frames, the block acknowledgement indicating whether or not regular acknowledgements may be used, in addition to the use of block acknowledgements, to acknowledge receipt of subsequent data frames.

The block acknowledgement may include a No Fragments field or a Block Ack Only field indicating whether or not transmission of data frames with a fragmented payload and regular acknowledgements may be used.

In an example embodiment, the block acknowledgement may include a multi-TID field that indicates whether the field, that indicates whether or not regular acknowledgements may be used, is provided for more than one traffic identifier.

In an example embodiment, the block acknowledgement may indicate that regular acknowledgements may be used to acknowledge subsequently transmitted data frames, and wherein the apparatus is further configured to: transmit one or more additional data frames having a fragmented payload; and receive one or more regular acknowledgements for one or more of the additional data frames.

An apparatus may include a processor, the apparatus being configured to: receive, via a wireless network, one or more data frames; and transmit a block acknowledgement that acknowledges receipt for one or more of the data frames, the block acknowledgement indicating whether or not regular acknowledgements may be used, in addition to the use of block acknowledgements, to acknowledge receipt of subsequent data frames.

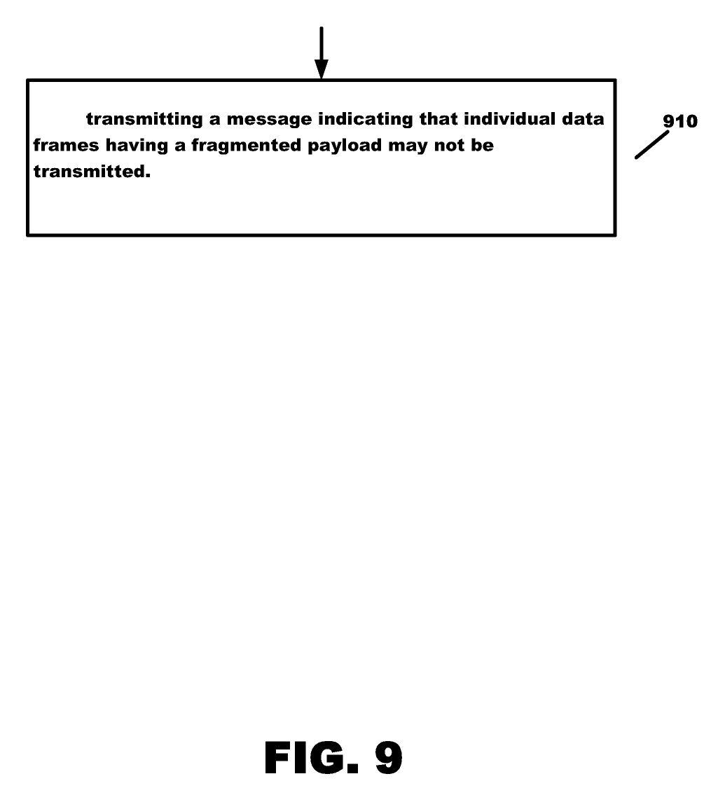

FIG. 9 is a flow chart illustrating operation of a wireless node according to an example embodiment. Operation 910 may include transmitting (e.g., by processor 1104 and/or transceiver 1102) a message indicating that individual data frames having a fragmented payload may not be transmitted. The method may further include establishing a use of block acknowledgements between a transmitting station and a receiving station; and wherein the transmitting comprises the receiving station transmitting a message indicating that individual data frames having a fragmented payload may not be transmitted to the receiving station.

In an example embodiment, the message may include a No Fragments field that indicates that individual data frames having a fragmented payload may not be transmitted.

In an example embodiment, the message is at least one of an add block acknowledgement (ADDBA) response, or a block Acknowledgement.

An apparatus may include a processor, the apparatus being configured to: transmit, via a wireless network, one or more data frames; and receive a block acknowledgement that acknowledges receipt for one or more of the data frames, the block acknowledgement indicating whether or not data frames with a fragmented payload may be transmitted.

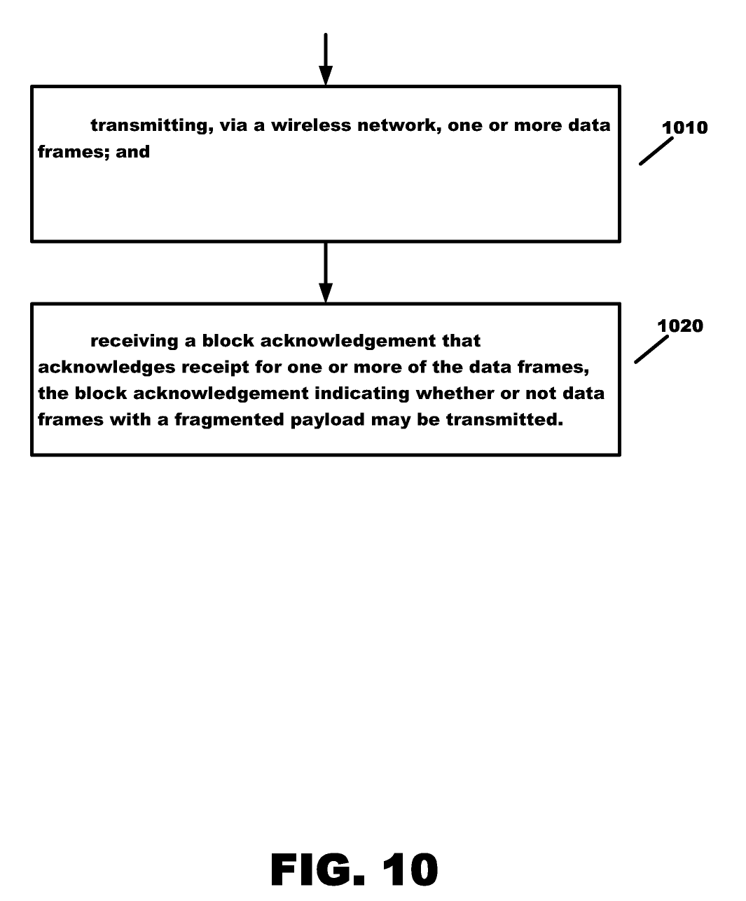

FIG. 10 is a flow chart illustrating operation of a wireless node according to an example embodiment.

Operation 1010 may include transmitting (e.g., by processor 1104 and/or transceiver 1102), via a wireless network, one or more data frames; and operation 1020 may include receiving (e.g., by processor 1104 and/or transceiver 1102) a block acknowledgement that acknowledges receipt for one or more of the data frames, the block acknowledgement indicating whether or not data frames with a fragmented payload may be transmitted.

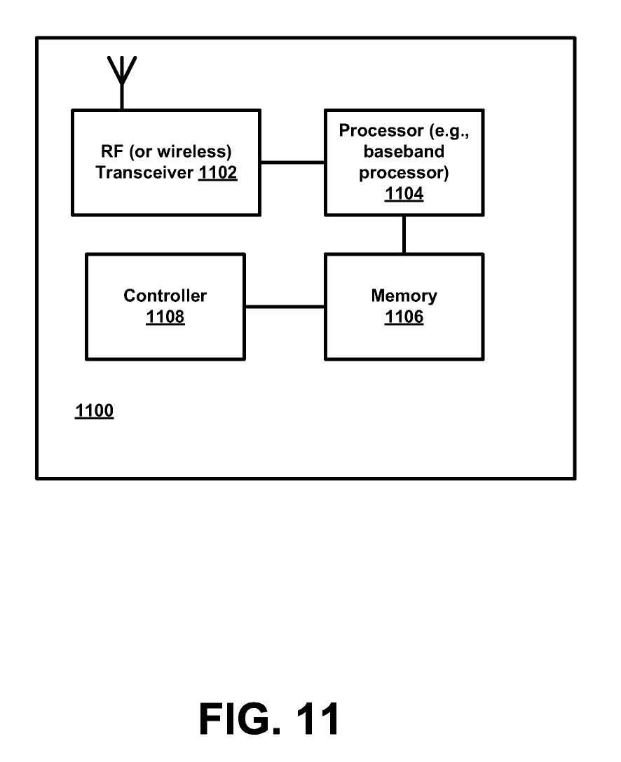

FIG. 11 is a block diagram of a wireless station (or wireless node) 1100 according to an example embodiment. The wireless station 1100 (e.g., base station 104 or mobile station 106, 108 or 110) may include, for example, an RF (radio frequency) or wireless transceiver 1102, including a transmitter to transmit signals and a receiver to receive signals, a processor 1104 to execute instructions or software and control transmission and receptions of signals, and a memory 1106 to store data and/or instructions.

Processor 1104 may also make decisions or determinations, generate frames or messages for transmission, decode received frames or messages for further processing, and other tasks or functions described herein. Processor 1104, which may be a baseband processor, for example, may generate messages, packets, frames or other signals for transmission via wireless transceiver 1102. Processor 1104 may control transmission of signals or messages over a wireless network, and may receive signals or messages, etc., via a wireless network (e.g., after being down-converted by wireless transceiver 1102, for example). Processor 1104 may be programmable and capable of executing software or other instructions stored in memory or on other computer media to perform the various tasks and functions described above, such as one or more of the tasks or methods described above. Processor 1104 may be (or may include), for example, hardware, programmable logic, a programmable processor that executes software or firmware, and/or any combination of these. Using other terminology, processor 1104 and transceiver 1102 together may be considered as a wireless transmitter/receiver system, for example.

In addition, referring to FIG. 11, a controller (or processor) 1108 may execute software and instructions, and may provide overall control for the station 1100, and may provide control for other systems not shown, such as controlling input/output devices (e.g., display, keypad), and/or may execute software for one or more applications that may be provided on wireless station 1100, such as, for example, an email program, audio/video applications, a word processor, a Voice over IP application, or other application or software.

In addition, a storage medium may be provided that includes stored instructions, which when executed by a controller or processor may result in the processor 1104, or other controller or processor, performing one or more of the functions or tasks described herein.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
transmitting, by an apparatus in a wireless network, a block acknowledgment request to another apparatus; and
receiving, from the another apparatus in response to the block acknowledgment request, a block acknowledgment response, the block acknowledgment response indicating whether the another apparatus supports data frames with fragmented payloads.

2. The method of claim 1, wherein the block acknowledgment request comprises an add block acknowledgment request and the block acknowledgment response comprises an add block acknowledgement response.

3. The method of claim 1, wherein the block acknowledgment request indicates whether the apparatus may transmit the data frames with fragmented payloads.

4. The method of claim 1, wherein:
the block acknowledgment response indicates that the another apparatus does not support data frames with fragmented payloads; and
the method further comprises transmitting data frames having complete or unfragmented payloads.

5. The method of claim 1, wherein:
the block acknowledgment request includes an identifier identifying a stream or flow for which block acknowledgments are requested; and
the block acknowledgment response indicates whether the block acknowledgments are supported.

6. An apparatus comprising:
at least one processor; and
at least one memory including computer program code configured to, with the at least one processor, cause the apparatus at least to:
transmit a block acknowledgment request to another apparatus via a wireless network; and
receive, from the another apparatus in response to the block acknowledgment request, a block acknowledgment response, the block acknowledgment response indicating whether the another apparatus supports data frames with fragmented payloads.

7. The apparatus of claim 6, wherein the block acknowledgment request comprises an add block acknowledgment request and the block acknowledgment response comprises an add block acknowledgement response.

8. The apparatus of claim 6, wherein the block acknowledgment request indicates whether the apparatus may transmit the data frames with fragmented payloads.

9. The apparatus of claim 6, wherein:
the block acknowledgment response indicates that the another apparatus does not support data frames with fragmented payloads; and
the computer program code is further configured to cause the apparatus to transmit data frames having complete or unfragmented payloads.

10. The apparatus of claim 6, wherein:
the block acknowledgment request includes an identifier identifying a stream or flow for which block acknowledgments are requested; and
the block acknowledgment response indicates whether the block acknowledgments are supported.

11. A method comprising:
receiving, by an apparatus in a wireless network, a block acknowledgment request from another apparatus; and
transmitting, to the another apparatus in response to the block acknowledgment request, a block acknowledgment response, the block acknowledgment response indicating whether the apparatus supports data frames with fragmented payloads.

12. The method of claim 11, wherein the block acknowledgment request comprises an add block acknowledgment request and the block acknowledgment response comprises an add block acknowledgement response.

13. The method of claim 11, wherein the block acknowledgment request indicates whether the another apparatus may transmit the data frames with fragmented payloads.

14. The method of claim 11, wherein:
the block acknowledgment response indicates that the apparatus does not support data frames with fragmented payloads; and
the method further comprises receiving data frames having complete or unfragmented payloads.

15. The method of claim 11, wherein:
the block acknowledgment request includes an identifier identifying a stream or flow for which block acknowledgments are requested; and
the block acknowledgment response indicates whether the block acknowledgments are supported.

16. An apparatus comprising:
at least one processor; and
at least one memory including computer program code configured to, with the at least one processor, cause the apparatus at least to:
receive a block acknowledgment request from another apparatus via a wireless network; and
transmit, to the another apparatus in response to the block acknowledgment request, a block acknowledgment response, the block acknowledgment response indicating whether the apparatus supports data frames with fragmented payloads.

17. The apparatus of claim 16, wherein the block acknowledgment request comprises an add block acknowledgment request and the block acknowledgment response comprises an add block acknowledgement response.

18. The apparatus of claim 16, wherein the block acknowledgment request indicates whether the another apparatus may transmit the data frames with fragmented payloads.

19. The apparatus of claim 16, wherein:
the block acknowledgment response indicates that the apparatus does not support data frames with fragmented payloads; and
the computer program code is further configured to cause the apparatus to receive data frames having complete or unfragmented payloads.

20. The apparatus of claim 16, wherein:
the block acknowledgment request includes an identifier identifying a stream or flow for which block acknowledgments are requested; and
the block acknowledgment response indicates whether the block acknowledgments are supported.
